(19) United States
(12) Patent Application Publication
(10) Pub. No.: US 2007/0163355 A1
(43) Pub. Date: Jul. 19, 2007

(54) Preformed sensor housing and methods to produce thin metal diaphragms

(75) Inventors: Marcos Nassar, Los Angeles, CA (US); Scott McDaniel, Simi Valley, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Kavlico Corporation, Moorpark, CA (US)

(21) Appl. No.: 11/332,754

(22) Filed: Jan. 13, 2006

(51) Int. Cl. G01L 7/08

(52) U.S. Cl. 73/715; 600/488

(57) ABSTRACT

A preformed senior housing including a conduit having an inside; a plug disposed within the conduit, and a deposit covering a portion of the plug and a portion of the conduit. A method is also disclosed for creating a thin film diaphragm on a housing including the step of inserting a sacrificial element into the housing; depositing a diaphragm material onto the sacrificial element and the housing; and removing the sacrificial element.

### BACKGROUND

1. Field of the Invention

The present invention relates generally to sensor housing construction, and more particularly, to preformed sensor housings and methods to produce thin metal diaphragms.

2. Background of the Invention

Diaphragms and membranes are structures that play a critical role in pressure sensors. Diaphragms are used in pressure sensors such that pressure is usually measured by detecting and quantifying the deflection of a diaphragm onto which pressure is applied. Another important application of diaphragms is to isolate two different media but still allow transmission of pressure from one medium to another. This is normally done to protect a pressure-sensing element from an incompatible environment by encapsulating the sensor in a housing that is filled with a neutral fluid such as silicone oil. The external pressure is transmitted to the oil, and therefore to the pressure sensor, through a flexible membrane that is hermetically attached to the housing. In this application, the diaphragm also functions as an isolation membrane to “isolate” one environment from the other. When these diaphragms and isolation membranes are metallic, they may be attached to housings by various methods such as welding, brazing, or with the use of adhesives. These attachment methods, however, are difficult to implement when the application requires very small diaphragms or membranes (i.e., diaphragms and membranes having very small diameters, or sizes). An example of such applications is implantable medical catheters used to measure pressure inside the body.

### SUMMARY OF THE PREFERRED EMBODIMENTS

The present invention is directed to preformed sensor housings and method for creating thin metal diaphragms on a housing. The diaphragm is preferably attached and hermetic sealed to the housing without the need of a separate attachment procedure such as laser welding or brazing. This method is particularly suited for producing miniature diaphragms and isolation membranes that cannot be easily attached to the rest of the mechanical system.

In one preferred embodiment, the method includes inserting a sacrificial element into a housing and then coating (e.g., via electroplating) the sacrificial element/housing combination with a material (e.g., metal) suitable for use as a diaphragm or isolation membrane. The sacrificial element will then be removed, which leaves behind the diaphragm attached to the housing.

In another preferred embodiment, the method described herein for creating a thin film diaphragm on a housing includes inserting a sacrificial element into the housing. Then, depositing a diaphragm material onto the sacrificial element and the housing, and removing the sacrificial element.

A sensor housing formed in accordance with one preferred embodiment of the present invention includes a conduit having an inside; a plug disposed inside the conduit; and a deposit covering at least a portion of the plug and a portion of the conduit.

Other objects, features and advantages will become apparent to those skilled in the art from the following detailed description. It is to be understood, however, that the detailed description and specific examples, while indicating exemplary embodiments, are given by way of illustration and not limitation. Many changes and modifications within the scope of the following description may be made without departing from the spirit thereof, and the description should be understood to include all such variations.

### BRIEF DESCRIPTION OF THE DRAWINGS

The invention may be more readily understood by referring to the accompanying drawings in which:

FIG. 1 is a cross-sectional view of a tube on which a diaphragm will be formed in accordance with one preferred embodiment of the present invention;

FIG. 2 is a cross-sectional view of the tube of FIG. 1 in which a sacrificial element is inserted in accordance with one preferred embodiment of the present invention;

FIG. 3 is a cross-sectional view of the tube of FIG. 2 on which a thin diaphragm is formed in accordance with one preferred embodiment of the present invention;

FIG. 4 is a cross-section view of the tube of FIG. 3 from which the sacrificial element is removed in accordance with one preferred embodiment of the present invention;

FIG. 5 is a cross-sectional view of a second tube in which an alternate version of a sacrificial element is inserted in accordance with one preferred embodiment of the present invention;

FIG. 6 is a cross-sectional view of a tube having a side-opening on which a diaphragm has been formed in accordance with one preferred embodiment of the present invention; and,

FIG. 7 is a flow diagram of a method of forming a thin diaphragm in accordance with one preferred embodiment of the present invention.

Like numerals refer to like parts throughout the several views of the drawings.

### DETAILED DESCRIPTION OF THE PREFERRED EMBODIMENTS

The present invention is directed to preformed sensor housings method for creating thin metal diaphragms on a housing. The thin metal diaphragm is attached to the housing and produces a seal (preferably hermetic) without the need of a separate attachment procedure such as laser welding or brazing. This method is particularly suited for producing miniature diaphragms and isolation membranes that cannot be easily attached to the rest of the mechanical system. In one preferred embodiment, the method includes inserting a sacrificial element into a tubular housing and then electroplating the sacrificial element/housing combination with a metal material suitable for use as a diaphragm or separation membrane. The sacrificial element can then be removed, which leaves behind the diaphragm attached to the housing.

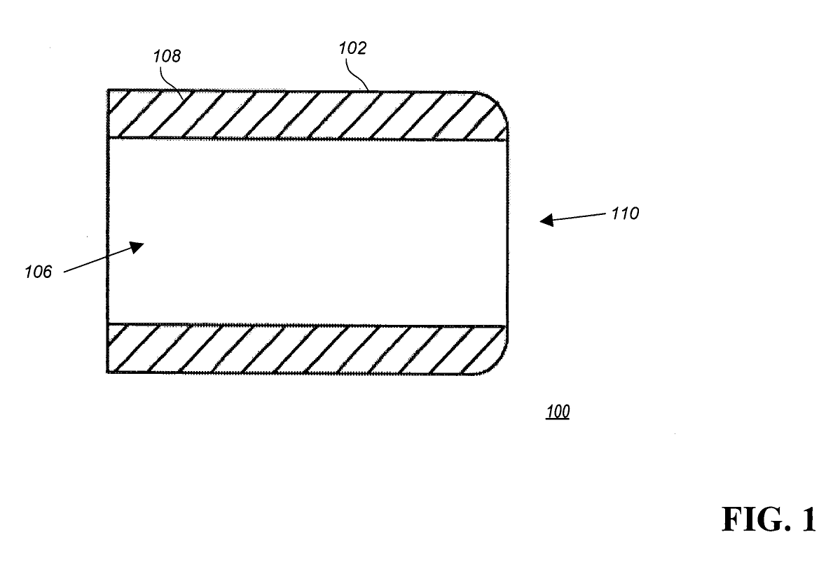

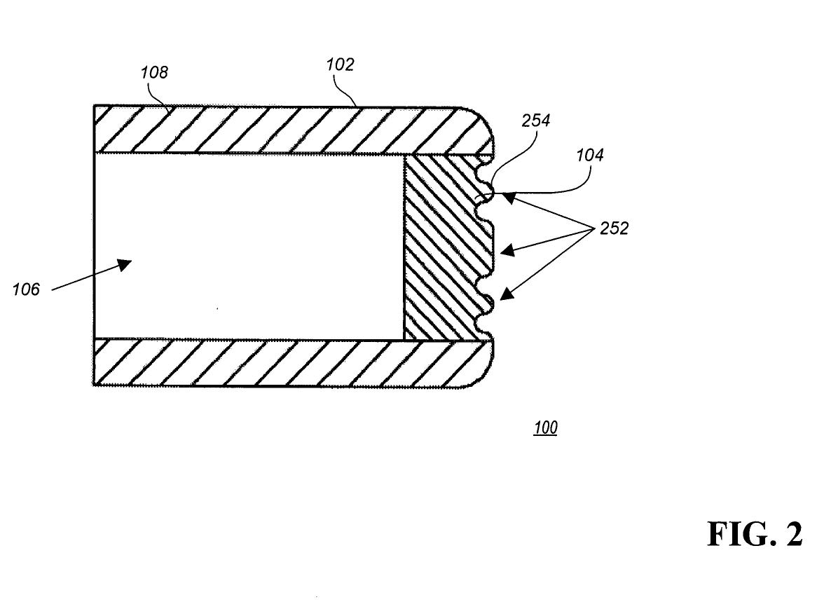

FIG. 1 will be used to describe a diaphragm formation process for a sensor tip assembly 100, which begins with the provision of a housing 102. In one preferred embodiment, housing 102 is metal and is tubular in shape. In other preferred embodiments, housing 102 may be formed of a variety of materials and have different cross-sections. Generally, the shape and structure of housing 102 may be thought of as a conduit. Housing 102 includes a front opening 110 and a sidewall 108 surrounding an interior 106. As illustrated in FIG. 2, a sacrificial element 104 is disposed in interior 106 of housing 102 at front opening 110, which is the end of housing 102 at which a diaphragm will be formed. The outer surface of sacrificial element 104 will determine the shape of the diaphragm that is formed thereon. In one preferred embodiment, sacrificial element 104 is configured with a plurality of ridges 252 on a corrugated surface 254. In other embodiments, sacrificial element 104 may be configured to have a variety of surface features, such as protrusions or indentations. For example, the surface may have bumps and/or dimples.

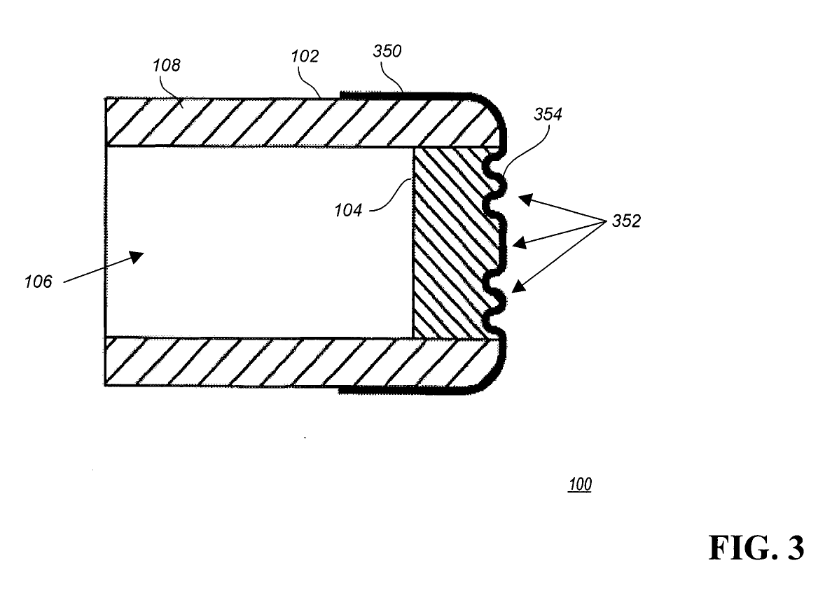

FIG. 3 illustrates the formation of a diaphragm 350 on sacrificial element 104 and housing 102. Diaphragm 350 comprises a suitable material that is deposited to a specific layer thickness. In one preferred embodiment, the formation of diaphragm 350 can be accomplished using electroplating, sputtering, or other deposition techniques. Diaphragm 350 includes a corrugated surface 354 that conforms to the surface configuration of corrugated surface 254, where corrugated surface 354 includes plurality of ridges 352 that also conforms to the surface configuration of corrugated surface 252 of sacrificial element 104.

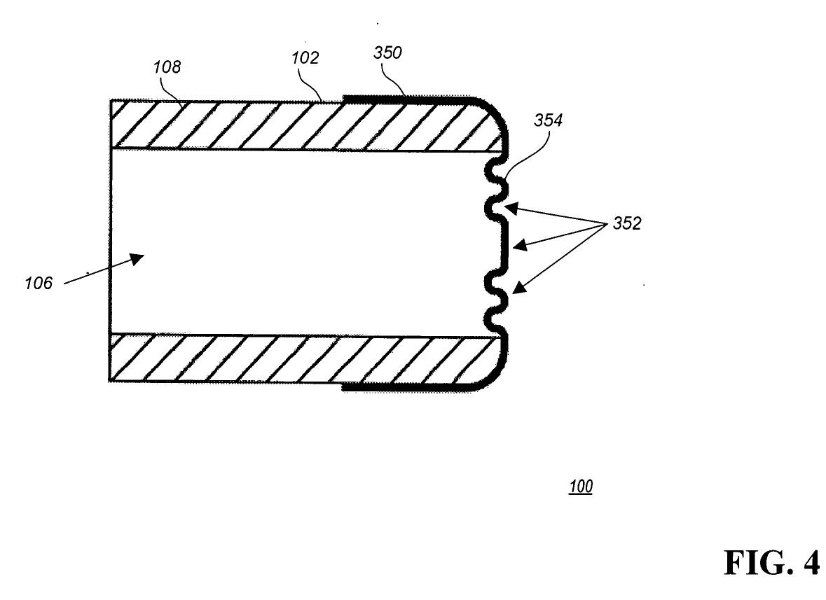

In one preferred embodiment of the present invention, after diaphragm 350 has been deposited, sacrificial element 104 is chemically or thermally removed, leaving diaphragm 350 hermetically attached to housing 102. FIG. 4 illustrates sensor tip assembly 100 where sacrificial element 104 has been removed. In one preferred embodiment, the material of sacrificial element 104 is chosen such that it can be chemically dissolved, melted or otherwise removed without affecting either housing 102 or diaphragm 350. Exemplary materials that may be used for the sacrificial element include copper, lead, solder, and/or conductive polymers/plastics. Exemplary materials that may be used for the diaphragm include chromium and/or nickel. Exemplary materials that may be used for the housing include stainless steel and/or titanium.

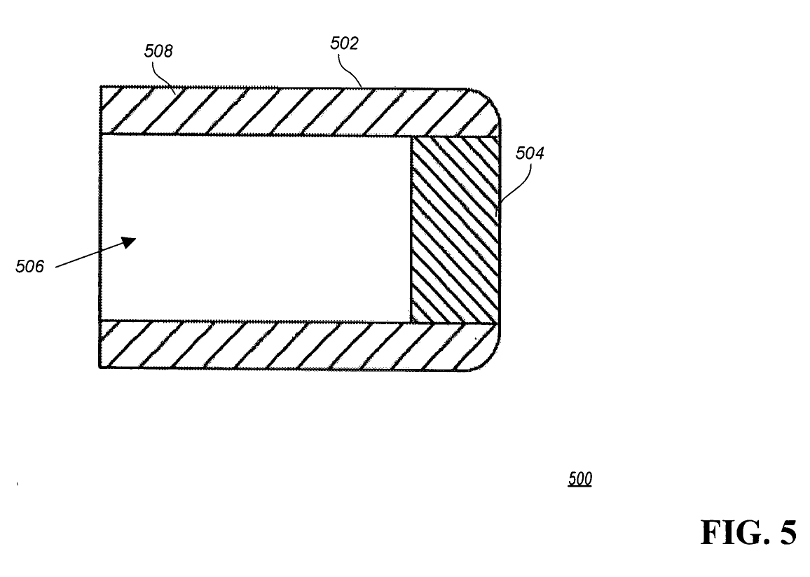

FIG. 5 illustrates a sensor tip assembly 500, which includes a housing 502 having a flat sacrificial element 504 displaced therein. Flat sacrificial element 504 does not have a surface pattern, so that a diaphragm formed thereon will be generally flat. In other embodiments, a sacrificial element may have different surface patterns to shape a diaphragm formed thereon.

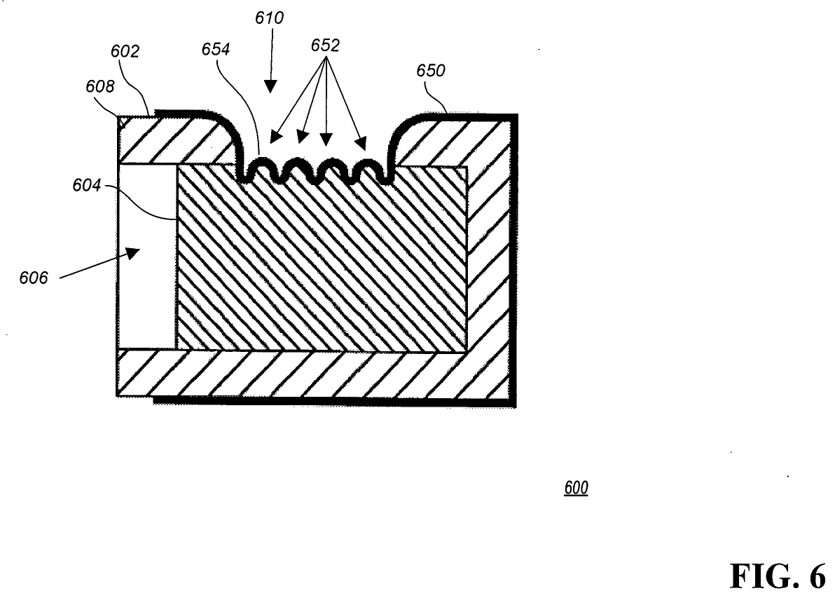

FIG. 6 shows an example of a diaphragm 650 fabricated on a side opening 610 of a housing 602 in accordance with one preferred embodiment of the present invention, where the shape of diaphragm 650 conforms to the outer surface pattern of a sacrificial element 604. Sacrificial element 604 is contained within an interior 606 of housing 602. For example, as illustrated in the figure, diaphragm 650 has a plurality of ridges 652 on a corrugated surface 654 that corresponds to the surface of sacrificial element 604.

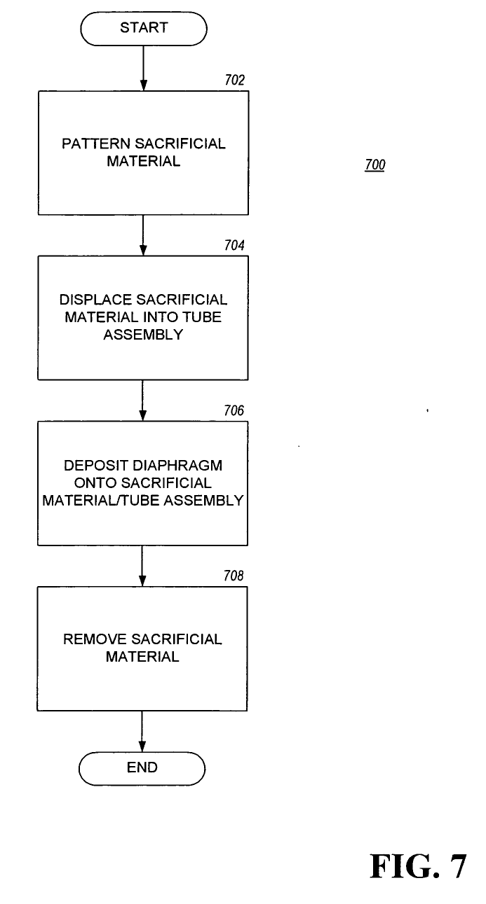

FIG. 7 illustrates a process 700 for producing diaphragms and membranes in accordance with one preferred embodiment of the present invention. Process 700 includes a combination of the described steps (e.g., creation of a sacrificial element having a shaped surface so that a diaphragm formed thereon will have particular surface features, insertion of that sacrificial element into a housing, use of electroplating to deposit a thin film for the diaphragm, and removal of the sacrificial element). In one preferred embodiment, the process for creating a thin diagram on a housing begins with step 702, where a plug or sacrificial element is configured so that the thin diaphragm that is ultimately formed, as described below, will be of a predetermined shape because it will conform to the surface pattern of the sacrificial element. The surface of the sacrificial element on which the diaphragm will be formed may be shaped such that the diaphragm will have a particular surface configuration (e.g., ridged or patterned). In this preferred embodiment, the sacrificial element is shaped before it is inserted into the tubular housing. The sacrificial element is then inserted into the tubular housing in step 704.

In another preferred embodiment, the sacrificial element is shaped after it is inserted into the housing. In this embodiment, the sacrificial element may be inserted into the housing without a high degree of precision and a portion of the sacrificial element left out because the portion that protrudes from the housing may be trimmed or shaped after it is inserted. Thus, in this embodiment, the steps of patterning the sacrificial element 702 and the displacement of the sacrificial element 704 are reversed as compared to the first preferred embodiment.

In yet another preferred embodiment, the patterning and displacement of the sacrificial element may occur simultaneously. For example, the tubular housing may have a cap that is shaped in the mirror image of the desired final shape of the sacrificial element and the sacrificial element is in liquid form when it is displaced into the tubular housing. Thus, when the sacrificial element solidifies in the tubular housing, the sacrificial element will take the form of the cap.

In still yet another preferred embodiment, the sacrificial element may be left without a particular patterned surface, such that the diaphragm that is formed will be relatively smooth and without a particular surface pattern.

In step 706, after the sacrificial element is inserted into the tubular housing, the diaphragm is formed onto the sacrificial element and the tubular housing. In one preferred embodiment, the diaphragm is formed by electroplating the sacrificial element/tubular housing combination with a metal material suitable for use as a diaphragm. For example, chromium, nickel, cadmium, platinum, and gold are exemplary preferred materials that may be electroplated onto the combined structure (i.e., the diaphragm material that is electroplated onto the sacrificial element/tubular housing combination). In another preferred embodiment, the diaphragm is formed by deposition of the diaphragm material onto the sacrificial element/tubular housing combination. For example, electroplating, electroless plating, and sputtering (for very thin diaphragms) are various deposition methods that may be used.

In step 708, the sacrificial element is then removed. As the diaphragm is formed onto the sacrificial element/housing combination in a contiguous manner, when the sacrificial element is removed, it leaves behind the diaphragm attached to the housing. In one preferred embodiment, the sacrificial element is removed by an etching process. The removal of the sacrificial element may be effected by such methods as metal etching (e.g., etching using, acids); melting (e.g., where the sacrificial material is lead and/or solder); and/or using solvents (e.g., where the sacrificial material is a conductive polymer and/or plastic). Preferably, after the removal of the sacrificial element, the diaphragm remains attached to the housing, with a hermetic seal between the diaphragm and housing without the need of a separate attachment procedure such as laser welding or brazing. As described herein, this method is particularly suited for producing miniature diaphragms and membranes that normally cannot be easily attached to the rest of the sensor system. This process offers great flexibility in terms of the shape and location of the diaphragm.

Thus, what has been described above is a method to fabricate small metal diaphragms and membranes by depositing a suitable metal or dielectric layer directly onto the surface of a housing. A portion of such housing incorporates a sacrificial element that is chemically or thermally removed after deposition, leaving a freestanding diaphragm attached to the rest of the housing at the perimeter of the membrane. The size and shape of the diaphragm is given by the size and shape of the surface of the sacrificial element. No further steps are required to attach the membrane to the housing.

The embodiments described above are exemplary embodiments. Those skilled in the art may now make numerous uses of, and departures from, the above-described embodiments without departing from the inventive concepts disclosed herein. Various modifications to these embodiments may be readily apparent to those skilled in the art, and the generic principles defined herein may be applied to other embodiments, without departing from the spirit or scope of the novel aspects described herein. Thus, the scope of the invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments. Accordingly, the present invention is to be defined solely by the scope of the following claims.

1. A preformed sensor housing comprising:
a conduit having an inside;
a plug disposed within the conduit; and
a deposit covering at least a portion of the plug and of the conduit.

2. The preformed sensor housing of claim 1, wherein the conduit has a substantially round cross-section.

3. The preformed sensor housing of claim 1, wherein the conduit is tubular.

4. The preformed sensor housing of claim 1, wherein the conduit comprises an opening, wherein the plug comprises a portion that is; exposed through the opening, the portion having a surface with a predetermined pattern.

5. The preformed sensor housing of claim 4, wherein the predetermined pattern is such that the deposit formed on the surface comprises a corrugated surface pattern.

6. The preformed sensor housing of claim 4, wherein the predetermined pattern is such that the deposit formed on the surface comprises a flat surface pattern.

7. The preformed sensor housing of claim 4, wherein the predetermined pattern is such that the deposit formed on the surface comprises a dimpled surface pattern.

8. The preformed sensor housing of claim 4, wherein the predetermined pattern is such that the deposit formed on the surface comprises a bumped surface pattern.

9. The preformed sensor housing of claim 4, wherein the predetermined pattern is a flat surface.

10. The preformed sensor housing of claim 1, wherein the plug is removable from the conduit.

11. The preformed sensor housing of claim 1, wherein the conduit is a medical catheter.

12. A method for creating a thin film diaphragm on a housing comprising:
inserting a sacrificial element into the housing:
depositing a diaphragm material onto a least a portion of the sacrificial element and the housing; and
removing the sacrificial element.

13. The method of claim 12, wherein the housing is a conduit.

14. The method of claim 12, wherein the housing comprise an opening and a wall surrounding the opening, wherein displacing the sacrificial element into the housing comprises inserting the sacrificial element to fill the opening up to the wall.

15. The method of claim 12, wherein depositing the diaphragm material onto the sacrificial element and the housing comprises electroplating the diaphragm material onto the sacrificial element and the housing.

16. The method of claim 12, wherein depositing the diaphragm material onto the sacrificial element and the housing comprises sputtering the diaphragm material onto the sacrificial element and the housing.

17. The method of claim 12, wherein depositing the diaphragm material onto the sacrificial element and the housing comprises electroless plating the diaphragm material onto the sacrificial element and the housing.

18. The method of claim 12, further comprising patterning the sacrificial element.

19. The method of claim 18, wherein patterning the sacrificial element comprises creating a corrugated pattern on a portion of the sacrificial element.

20. The method of claim 18, wherein patterning the sacrificial element comprises creating a dimpled pattern on a portion of the sacrificial element.)

21. The method of claim 18, wherein patterning the sacrificial element comprises creating a bumped pattern on a portion of the sacrificial element.

22. The method of claim 18, wherein patterning the sacrificial element comprises creating a flat surface on a portion of the sacrificial element.

23. The method of claim 12, wherein removing the sacrificial element comprises thermally removing the sacrificial element.

24. The method of claim 12, wherein removing the sacrificial element comprises chemically removing the sacrificial element.

25. The method of claim 24, wherein chemically removing the sacrificial element comprises etching the sacrificial element.

26. The preformed sensor housing of claim 4, wherein the plug comprises a side surface and a front face, and the front face is exposed through the opening.

27. The preformed sensor housing of claim 26, wherein the front face is the only portion of the plug that is exposed through the opening.

28. The preformed sensor housing of claim 10, wherein the plug is removable from the conduit through chemical etching.

29. The preformed sensor housing of claim 10, wherein the plug is removable from the conduit through thermal decomposition.
